(19) United States
(12) Patent Application Publication
(10) Pub. No.: US 2009/0117518 A1
(43) Pub. Date: May 7, 2009

(54) DENTURE TEETH DEVICE AND METHOD

(75) Inventor: Joseph J. Massad, Tulsa, OK (US)

Correspondence Address: HEAD, JOHNSON & KACHIGIAN, 228 W 17TH PLACE, TULSA, OK, 74119, US

(73) Assignee: GLOBAL DENTAL IMPRESSION TRAYS, INC., Tulsa, OK (US)

(21) Appl. No.: 12/108,100

(22) Filed: Apr. 23, 2008

Related U.S. Application Data
(60) Provisional application No. 60/986,149, filed on Nov. 7, 2007.

(51) Int. Cl. A61C 13/007

(52) U.S. Cl. 433/171; 433/215

(57) ABSTRACT

A denture teeth device having a wire, strand or thread, or a plurality of wires adjustably coupled to a plurality of denture teeth to form a unit. The wire may be adjustably coupled along the lingual-apical portions of the denture teeth. The wire may be flexible to permit development of a dental arch form so that the denture teeth can be readily adapted to individual patient needs. The wire may also serve to improve denture tooth retention in a processed denture base. The wire may be adjustably coupled to the denture teeth so as to not constrain the denture teeth along the length of the wire, allowing for customized arrangement of the denture teeth, including the incorporation of denture tooth overlaps, vertical and horizontal discrepancies, diastemata and facial-lingual and mesial-distal angular variation. The apical and lingual portions of the denture teeth may be contoured to facilitate the creation of anatomically realistic and hygienically favorable papilla forms and occlusion or the patient's bite.

### CROSS-REFERENCE TO RELATED APPLICATIONS

This application claims priority to U.S. Provisional Application No. 60/986,149, filed Nov. 7, 2007.

### BACKGROUND OF THE INVENTION

1. Field of the Invention

This invention relates to a denture teeth device and a method to construct denture teeth. In particular, the invention relates to anterior or posterior maxillary and mandibular denture teeth held in relation using a wire, strand or thread and to a method of denture construction using the denture teeth device, both of which facilitate rapid and accurate set-up of denture teeth to be readily adapted to individual patient needs.

2. Prior Art

The laboratory fabrication of complete dentures necessitates a balance between artistic creativity and scientific principles. Successful laboratory technicians develop these skills over many years of trial and improvement. Though much of denture construction involves historically proven, scientifically honed procedures, current methods are overwhelmingly artistic in nature and therefore remarkably time consuming. Of particular concern is the need to specifically manipulate each individual denture tooth during denture set-up procedures. Individual tooth set-up is biomechanically demanding, time consuming and unique to each patient involved.

It is therefore desirable to provide a denture teeth device and method that procedurally enhances and simplifies the demanding and time consuming laboratory fabrication process of complete dentures.

It is further desirable to provide a denture teeth device and a method that streamlines denture construction by facilitating rapid and accurate setup of denture teeth.

It is further desirable to provide a denture teeth device and a method capable of structurally combining denture teeth into an anatomically accurate composite.

It is further desirable to provide a denture teeth device and a method capable of being set into a denture as a unit to greatly expediting and simplifying setup of denture teeth and dentures.

It is further desirable to provide a denture teeth device and a method that permits easy development of the dental arch form allowing the denture teeth to be readily adapted to individual patient needs.

It is further desirable to provide a denture teeth device and a method that improves denture tooth retention in a processed denture base.

It is further desirable to provide a denture teeth device and a method that expands existing clinical applications and restorative possibilities.

It is further desirable to provide a denture teeth device and a method that permits manipulation of each individual dental tooth allowing for customized arrangements of the denture teeth, including the incorporation of denture tooth overlaps, vertical discrepancies, horizontal discrepancies, diastemata, facial-lingual angular variation and mesial-distal angular variation.

It is further desirable to provide a denture teeth device and a method that facilitates the creation of anatomically realistic and hygienically favorable papilla forms.

It is further desirable to provide a denture teeth device and a method that aids in the speed and accuracy of denture base wax-up and finishing of the processed denture.

### SUMMARY OF THE INVENTION

In a first aspect, the present invention relates to a denture teeth device having a wire, strand or thread adjustably coupled to a plurality of denture teeth to form a unit. Embodiments of the invention may include one or more of the following features. The denture teeth may be maxillary denture teeth and/or mandibular denture teeth. The denture teeth may be anterior or posterior denture teeth. The denture teeth may be constructed of porcelain or any biocapable resin or other material. The denture teeth may be contoured near an apical portion and/or lingual or cervical portion, allowing a denture base to have anatomically accurate papilla. The wire, strand or thread may be adjustably coupled to a lingual or cervical portion and/or near an apical portion of the denture teeth along a longitudinal groove that allows overlap, vertical discrepancies, horizontal discrepancies, diastemata, facial-lingual angular variation or mesial-distal angular variation of the denture teeth. The wire, strand or thread may be sufficiently flexible in order to allow development of a dental arch.

In a second aspect, the present invention relates to a method of use of the denture teeth device involving the steps of fitting the denture device to a patient's oral cavity and setting the denture device as a unit into a denture, wherein the denture device includes a wire adjustably coupled to a plurality of denture teeth. The method may include the steps of forming a dental arch with the denture device to match the patient's dental arch and desired occlusion. The teeth can also be moved in the wire apically or occlusally to match the desired occlusion or bite. The method may further include the steps of manipulating each denture tooth to overlap or have vertical discrepancies, horizontal discrepancies, diastemata, facial-lingual angular variation or mesial-distal angular variation of the denture teeth.

### BRIEF DESCRIPTION OF THE DRAWINGS

FIG. 1 is a perspective view of a preferred embodiment of the present invention wherein a wire, strand or thread is adjustably coupled to the lingual-apical portion of anterior maxillary denture teeth;

FIG. 2 is a perspective view of an embodiment of the invention wherein a wire, strand or thread is adjustably coupled to the lingual-apical portion of anterior mandibular denture teeth;

FIG. 3 is a perspective view of an embodiment of the invention wherein wires are adjustably coupled to the lingual-apical portion of anterior maxillary and mandibular denture teeth;

FIG. 4 is a top perspective view of an embodiment of the invention set into a denture;

FIG. 5 is a perspective view of an embodiment of the invention wherein the denture teeth have been manipulated to overlap or have vertical discrepancies, horizontal discrepancies, diastemata, facial-lingual angular variation or mesial-distal angular variation; and

FIG. 6 is a perspective view of an alternate preferred embodiment of the present invention.

### DETAILED DESCRIPTION OF THE PREFERRED EMBODIMENTS

The devices and methods discussed herein are merely illustrative of specific manners in which to make and use the invention and are not to be interpreted as limiting in scope.

While the devices and methods have been described with a certain degree of particularity, it is to be noted that many modifications may be made in the details of the construction and the arrangement of the devices, methods and components without departing from the spirit and scope of this disclosure. It is understood that the devices and methods are not limited to the embodiments set forth herein for purposes of exemplification.

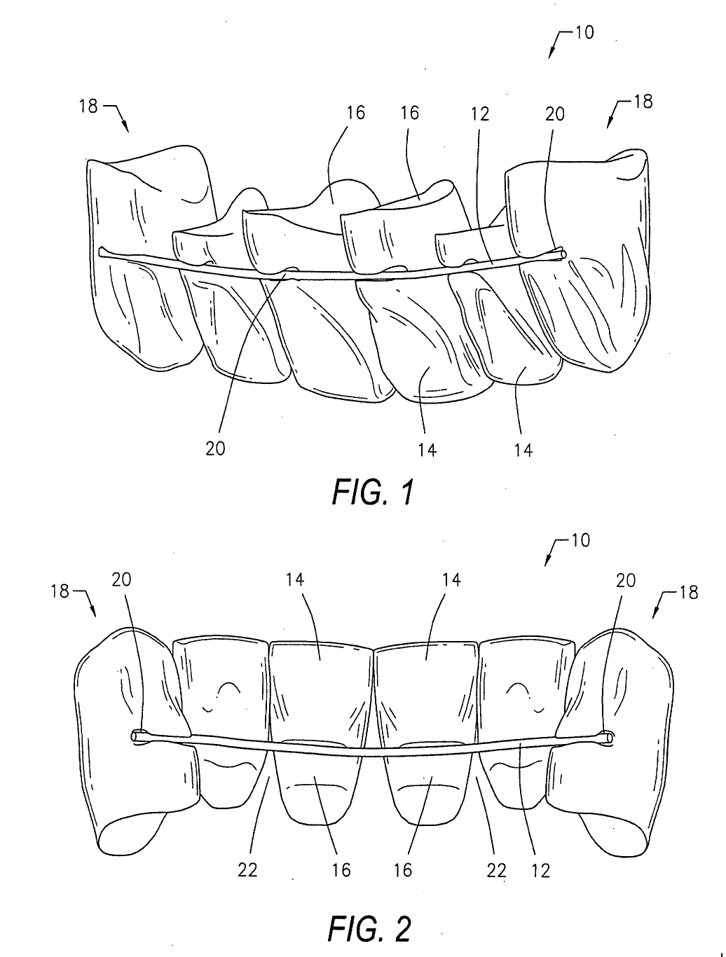

Referring to the figures of the drawings, wherein like numerals of reference designate like elements throughout the several views, particularly to FIG. 1, there is shown a perspective view of a preferred embodiment of a dental device 10 having a wire, strand or thread 12 adjustably coupled to a plurality of denture teeth 18 to form a unit. In the embodiment shown, six teeth are utilized although a greater or lesser number of teeth may be employed within the spirit and scope of the present invention. The wire 12 may be fabricated from flexible metal or from other material. Ideally, the wire 12 will be flexible so it may be manipulated by the dentist or dental technician yet hold a position thereafter.

The denture teeth 18 may be contoured on a lingual portion 14. The denture teeth 18 may also be contoured near an apical portion 16. The contour of denture teeth 18 facilitates preparation of anatomically correct papilla 22 in a denture base, as best shown in FIGS. 2, 3 and 4.

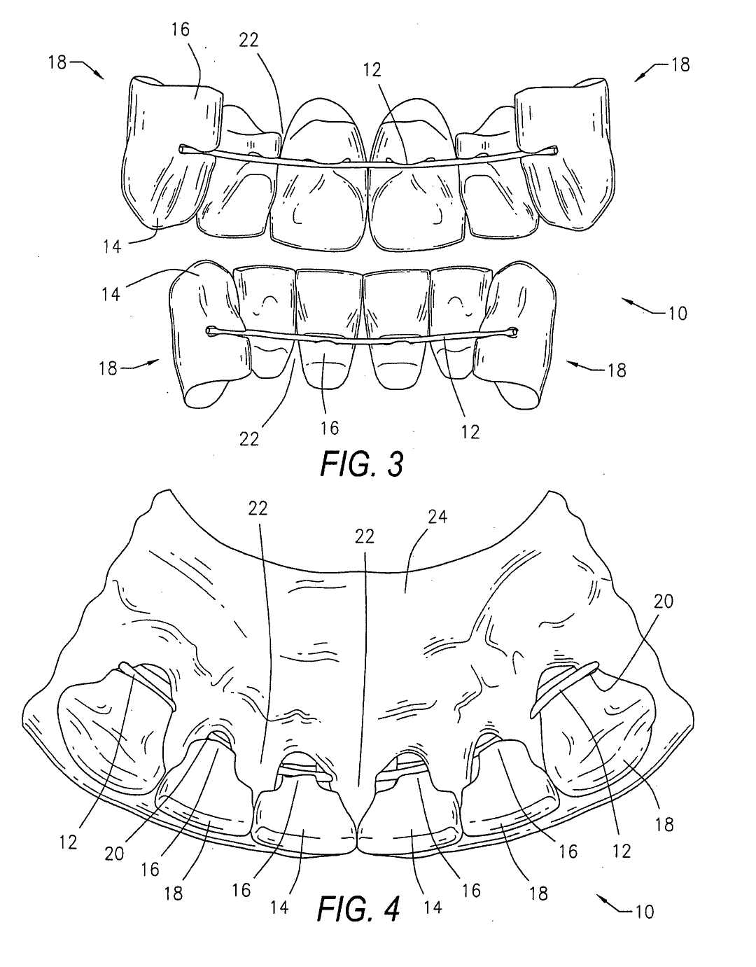

The denture teeth 18 may be maxillary denture teeth as shown in FIG. 1, mandibular denture teeth as shown in FIG. 2 or both as shown in FIG. 3. Each of the denture teeth 18 are elongated, as is well known. The wire, strand or thread 12 may be adjustably coupled along a horizontal recess or groove 20 to the lingual portion 14 only (not shown), near the apical portion 16 only (not shown) or both the lingual portion 14 and the apical portion 16 of denture teeth 18, as depicted in FIGS. 1 through 5. The wire, strand or thread 12 may be sufficiently flexible to facilitate the development of a dental arch, which allows the denture device 10 to be readily manipulated and therefore adapted to individual patient needs.

In addition, the wire 12 may assist the retention of the denture teeth 18 in a denture base 24. The denture base 24 may be fabricated from acrylic or other material. In one non-limiting example, the denture teeth device 10 may be set into the denture base 24 as shown in FIG. 4. Because each of the dental teeth 18 may be contoured, papilla 22 in the denture base 24 can be anatomically realistic and hygienically favorable. Moreover, it has been found that contour of the dental teeth permits fabrication of papilla that assists in retention and proper elimination of food debris in between each denture tooth. Additionally, vertical recesses in each tooth (not visible) between adjacent teeth permits reception of papilla to assist in retention of the teeth in the base.

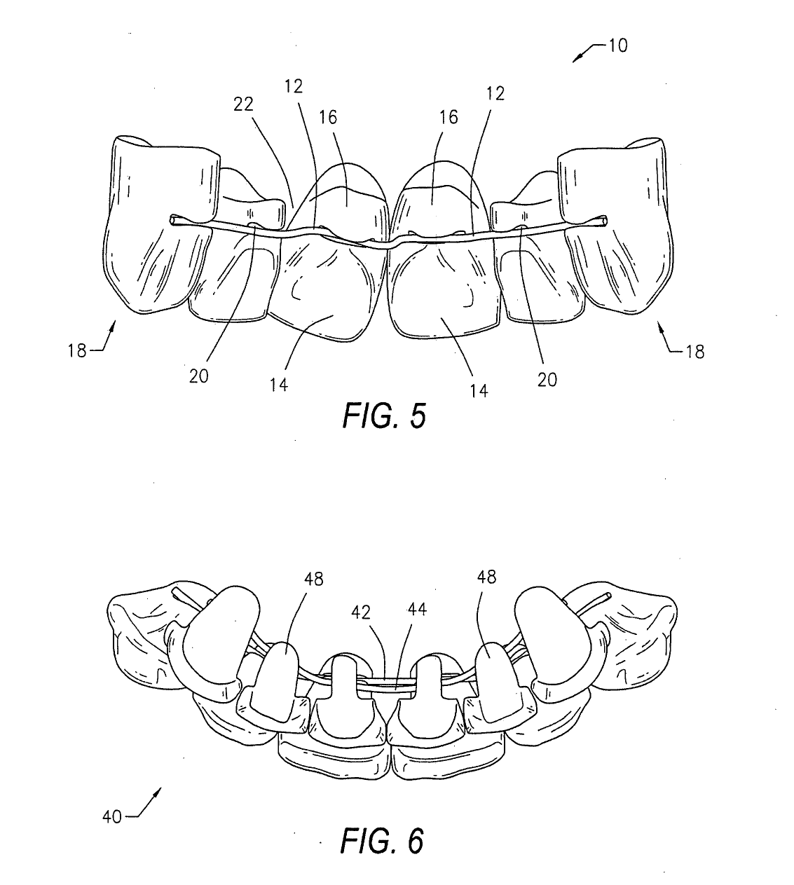

The wire 12 permits movement of the individual teeth 18 horizontally, vertically and angularly with respect to each other. Additionally, the wire forms an axis for rotational movement of each individual tooth 18. The recess or groove 20 in each tooth 18 allows overlap, vertical discrepancies, horizontal discrepancies, diastemata, facial-lingual angular variation or mesial-distal angular variation of the denture teeth 18, as best shown in FIG. 5. The ability to manipulate each individual denture tooth aids in the speed and accuracy of denture base wax-up and finishing of the processed denture.

The denture teeth 18 may be made of porcelain or other known materials for denture teeth. The capability of the denture teeth device 10 to use porcelain denture teeth 18 in combination with the capability of the wire, strand or thread 12 to assist in the retention of the denture teeth 18 in denture base 24 vastly expands existing clinical applications and restorative possibilities.

A method of constructing a denture is also contemplated herein and comprises a number of steps. Initially, a denture device is prepared having a wire adjustably coupled to a plurality of denture teeth. The denture device is inserted into the patient's oral cavity and the denture device 10 is set as a unit.

The fitting of the denture device 10 may include forming a dental arch by flexing the wire of the denture device such that the shape of the denture device matches the patient's dental arch. The fitting of the denture device may further include arranging the denture teeth 18 by manipulating each denture tooth, which may be accomplished by horizontal, vertical or angular movement of the individual teeth 18, overlap, vertical discrepancies, horizontal discrepancies, diastemata, facial-lingual angular variation or mesial-distal angular variation of the denture teeth. In addition, the setting of the denture device 10 may involve creating anatomically correct papilla forms from the contours in the denture tooth.

FIG. 6 illustrates a perspective view of an alternate embodiment of a dental device 40 having a pair of strands, threads or wires 42 and 44 adjustably coupled to a plurality of denture teeth 48 in order to form a unit. The wires 42 and 44 may be fabricated from flexible metal or from other material such as resin that may be light cured to lock or fix into position when the desired arrangement is approved. Ideally, the wires 42 and 44 will be flexible so that they may be manipulated by the dentist or dental technician yet hold a position thereafter.

The denture teeth 48 may be contoured on a lingual portion. The denture teeth may also be contoured near an apical portion.

Whereas, the devices and methods have been described in relation to the drawings and claims, it should be understood that other and further modifications, apart from those shown or suggested herein, may be made within the spirit and scope of this invention.

1. A denture device, comprising:
a plurality of denture teeth;
at least one wire, strand or thread adjustably coupled to said plurality of denture teeth to form a unit, wherein said wire, strand or thread is adjustably coupled to each of said denture teeth along a longitudinal groove on a lingual portion and near an apical portion of said denture teeth; and
means to permit mesial-distal angular variation or rotation of each of said plurality of denture teeth about said wire, strand or thread.

2. The denture device of claim 1 wherein said denture teeth are maxillary denture teeth.

3. The denture device of claim 1 wherein said denture teeth are mandibular denture teeth.

4. The denture device of claim 1 wherein said denture teeth are anterior or posterior denture teeth.

5. The denture device of claim 1 wherein said denture teeth are constructed of porcelain or other resin such as acrylic.

6. The denture device of claim 1 wherein said denture teeth are contoured near an apical portion.

7. The denture device of claim 6 wherein said denture teeth are contoured on a lingual portion.

8. The denture device of claim 1 wherein said denture teeth are contoured to allow a denture base to have anatomically accurate papilla.

9. (canceled)

10. (canceled)

11. (canceled)

12. The denture device of claim 1 wherein said wire, strand or thread adjustably coupled along said groove allows overlap, vertical discrepancies, horizontal discrepancies, or diastemata, facial-lingual angular variation.

13. The denture device of claim 1 wherein said wire, strand or thread adjustably coupled to said denture teeth permits horizontal, vertical or angular movement of each tooth with respect to the others.

14. The denture device of claim 1 wherein said denture device is capable of being set into a denture.

15. The denture device of claim 1 wherein said wire is sufficiently flexible to allow development of a dental arch with said denture device.

16. The denture device of claim 1 wherein said wire is a plurality of wires.

17. A method of constructing a denture, comprising the steps of:
fitting a denture device to a patient's oral cavity, wherein said denture device comprises a wire, strand or thread adjustably coupled to each of a plurality of denture teeth along a longitudinal groove on a lingual portion and near an apical portion of said denture teeth; and
setting said denture device as a unit into a denture.

18. The method of claim 17 wherein said step of fitting said denture device further comprises the step of forming a dental arch by flexing said wire of said denture device to match said patient's dental arch.

19. The method of claim 17 wherein said step of fitting said denture device further comprises the step of arranging said denture teeth by manipulating each denture tooth.

20. The method of claim 19 wherein said step of arranging said denture teeth is accomplished by overlap, vertical discrepancies, horizontal discrepancies, diastemata, facial-lingual angular variation or mesial-distal angular variation of said denture teeth.

21. The method of claim 17 wherein said step of setting said denture device further comprises the step of creating anatomically correct papilla forms from contours in said denture teeth.
